(19) United States
(12) Patent Application Publication
(10) Pub. No.: US 2022/0417663 A1
(43) Pub. Date: Dec. 29, 2022

(54) MICRO-SPEAKER AND DAMPER FOR MICRO-SPEAKERS

(71) Applicant: Vanson Electronics (Nanhai) Co., Ltd., Foshan City (CN)

(72) Inventors: Ching-Shan Hsu, Taipei City (TW); Hao-Chien Hsu, Taipei City (TW)

(73) Assignee: Vanson Electronics (Nanhai) Co., Ltd., Foshan City (CN)

(21) Appl. No.: 17/509,072

(22) Filed: Oct. 25, 2021

Related U.S. Application Data
(63) Continuation-in-part of application No. 17/380,005, filed on Jul. 19, 2021.

(30) Foreign Application Priority Data
Jun. 25, 2021 (CN) 202110711697.3
Sep. 27, 2021 (CN) 202111136925.5

(51) Int. Cl. H04R 7/26; H04R 9/02

(52) U.S. Cl. CPC H04R 7/26; H04R 9/025

(57) ABSTRACT

A micro-speaker includes a frame body, a diaphragm arranged on the frame body, a magnetic structure and a voice coil arranged in the frame body. An upper end of the voice coil is fixed to the diaphragm. The magnetic structure is arranged under the voice coil. A voice coil balancing system is provided in the frame body, which is composed of two symmetrically arranged dampers and two symmetrically arranged elastic members, which are paired and respectively arranged at mounting portions under two opposite ends of a long axis of the frame body and fixed with glue. Each of the two dampers is made of a flexible circuit board, including a first end, a second end and a cantilever connecting the first end and the second end. A ratio of a length L of the cantilever to a distribution distance D of the cantilever is between 2-15.

### CROSS REFERENCE TO RELATED APPLICATIONS

This is a continuation-in-part of U.S. application Ser. No. 17/380,005 filed Jul. 19, 2021, which is included in its entirety herein by reference.

### BACKGROUND OF THE INVENTION

### 1. Field of the Invention

The invention relates to the technical field of loudspeaker, in particular to a micro-speaker and a damper for micro-speakers.

### 2. Description of the Prior Art

A loudspeaker is a kind of transducer element that converts electrical signals into acoustic signals, and is an important acoustic component in electronic products. The speaker module usually includes a frame and a magnetic system and a vibration system disposed within the frame. The vibration system includes a diaphragm and a voice coil arranged under the diaphragm. The voice coil drives the diaphragm to produce sound under the vibration of the magnetic system.

With the high pursuit of portability of electronic products, reducing the size is a necessary goal when updating various micro-speaker products, but the reduction in volume means that the volume of the magnet of the micro-speaker must be reduced at the same time, resulting in a decrease in output of the sound. Increasing the power may compensate the decrease in output of the sound caused by the smaller magnet. However, the micro-speaker faces the risk of tearing the voice coil lead due to excessive amplitude.

### SUMMARY OF THE INVENTION

It is one objective of the present invention to provide a micro-speaker and a damper for the micro-speaker, so as to solve the above-mentioned problems of the prior art.

In order to achieve the above objectives, the present disclosure provides the following technical solutions.

A micro-speaker includes a frame body, a diaphragm arranged on the frame body, a magnetic structure and a voice coil arranged in the frame body. An upper end of the voice coil is fixed to the diaphragm. The magnetic structure is arranged under the voice coil. A voice coil balancing system is provided in the frame body, which is composed of two symmetrically arranged dampers and two symmetrically arranged elastic members, which are paired and respectively arranged at mounting portions under two opposite ends of a long axis of the frame body and fixed with glue. Each of the two dampers is made of a flexible circuit board, including a first end, a second end and a cantilever connecting the first end and the second end. A ratio of a length L of the cantilever to a distribution distance D of the cantilever is between 2-15.

According to some embodiments, each of the two dampers has a left-right symmetrical structure.

According to some embodiments, the cantilever has no copper layer on a front surface of each of the two dampers.

According to some embodiments, each of the two dampers comprises a substrate that is made of a polymer material.

According to some embodiments, a voice coil lead is fixed to a welding part located at a center portion of the first end on a front surface of each of the two dampers by using spot welding, which is connected to a circuit on a bottom surface of each of the two dampers through a via hole, which is electrically connected to a connection terminal on the bottom surface of the second end.

According to some embodiments, an external signal wire is welded to the connection terminal on the bottom surface of the second end.

According to some embodiments, a width of the cantilever is 0.45 mm.

According to some embodiments, the diaphragm is arranged in a slender shape, and wherein a size of the diaphragm in a length direction is larger than a size in a width direction.

According to some embodiments, the frame body has an opening that matches a shape of the diaphragm, and the diaphragm is connected to the frame body through a ring-shaped surround to seal the opening.

According to some embodiments, the magnetic structure includes a main magnetic portion and a yoke under the main magnetic portion, and wherein a gap is located between the main magnetic portion and the yoke, and the voice coil is disposed around the outer periphery of the main magnetic portion and installed in the gap.

According to some embodiments, a washer for magnetic conduction is provided on the main magnetic portion.

According to some embodiments, the dampers are fixed under the two opposite ends of the long axis of the frame body with the glue through the second ends.

According to some embodiments, each of the two elastic members is a composite film with a sandwich structure.

According to some embodiments, the composite film comprises a composite sandwich structure of polyetheretherketone/adhesive layer/polyetheretherketone or a composite sandwich structure of thermoplastic polyester elastomer/adhesive layer/thermoplastic polyester elastomer, wherein the adhesive layer is acrylic glue.

According to some embodiments, each of the two elastic members is composed of a single material.

According to some embodiments, the single material is silicone resin.

According to some embodiments, each of the two elastic members includes an inner edge portion and an outer edge portion, the shapes of which respectively correspond to the first end and the second end of the damper. The inner edge portion and the outer edge portion of each of the two elastic members are adhered to the first end and the second end of the damper, respectively.

According to some embodiments, each of the two elastic members is provided with a connecting portion between the inner edge portion and the outer edge portion, which has a wavy or arc-shaped cross-sectional profile and has wrinkles.

According to some embodiments, the connecting portion is discontinuous and is arranged at a corner with an opening in the middle to expose part of the damper.

According to some embodiments, the connecting portion is continuous and completely covers the damper.

Compared with the prior art, the present invention has the following beneficial effects: by providing voice coil balancing system consisting of the dampers formed by flexible circuit boards and the elastic members on the voice coil, sufficient elasticity and damping can be provided to reduce the vibration of the voice coil leads, thereby increasing the rated power, and passing life test under high power operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the appearance of a micro-speaker according to an embodiment of the present invention.

FIG. 2 is an exploded view of the micro-speaker in FIG. 1.

FIG. 3 is a schematic diagram showing the front-side layout of the damper.

FIG. 4 is a schematic diagram showing the bottom-side layout of the damper.

FIG. 5 shows the length L, width W and distribution distance D of the cantilever of the damper.

FIG. 6 is a schematic bottom view of a micro-speaker according to another embodiment of the present invention.

FIG. 7 is an exploded view of the micro-speaker in FIG. 6.

FIG. 8 shows the cantilever length L, width W and distribution distance D of the damper.

FIG. 9 is a schematic diagram showing the front-side layout of the damper.

FIG. 10 is a schematic diagram showing the bottom-side layout of the damper.

FIG. 11 is a schematic bottom view of a micro-speaker according to still another embodiment of the present invention.

### DETAILED DESCRIPTION

In order to make the objectives, technical solutions, and advantages of the embodiments of the present invention clearer, the technical solutions in the embodiments of the present invention will be described clearly and completely in conjunction with the accompanying drawings in the embodiments of the present invention. Obviously, the described embodiments are part of the embodiments of the present invention, but not all of the embodiments. Based on the embodiments of the present invention, all other embodiments obtained by those of ordinary skill in the art without creative work shall fall within the protection scope of the present invention. Therefore, the following detailed description of the embodiments of the present invention provided in the accompanying drawings is not intended to limit the scope of the claimed invention, but merely represents selected embodiments of the present invention.

In the description of the present invention, it should be understood that the terms “center”, “longitudinal”, “transverse”, “length”, “width”, “thickness”, “upper”, “lower”, “front”, “back”, “left”, “Right”, “vertical”, “horizontal”, “top”, “bottom”, “inner”, “outer”, “clockwise”, “counterclockwise” and other directions or the positional relationship are based on the orientation or positional relationship shown in the drawings, and is only for the convenience of describing the present invention and simplifying the description, and does not indicate or imply that the pointed device or element must have a specific orientation, be constructed and operated in a specific orientation, Therefore, it shall not be interpreted as a limitation to the present invention.

In the present invention, unless otherwise clearly defined and specified, the “above” or “below” of the first feature of the second feature may include direct contact between the first and second features, or may include the first and second features not in direct contact but through other features between them. Moreover, “above”, “above” and “above” the second feature of the first feature include the first feature being directly above and obliquely above the second feature, or it simply means that the first feature is higher in level than the second feature. The “below”, “below” and “below” of the second feature of the first feature include the first feature directly below and obliquely below the second feature, or it simply means that the level of the first feature is smaller than the second feature.

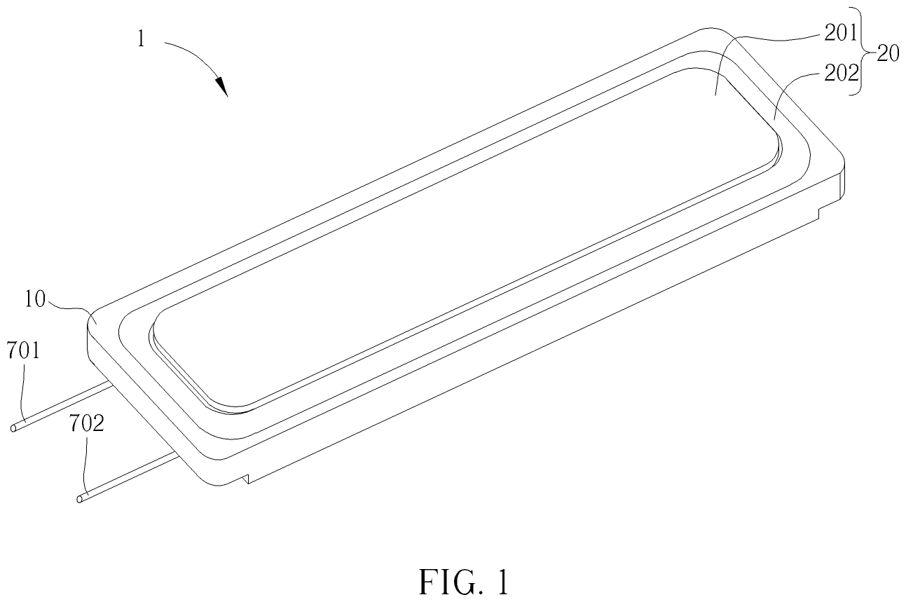

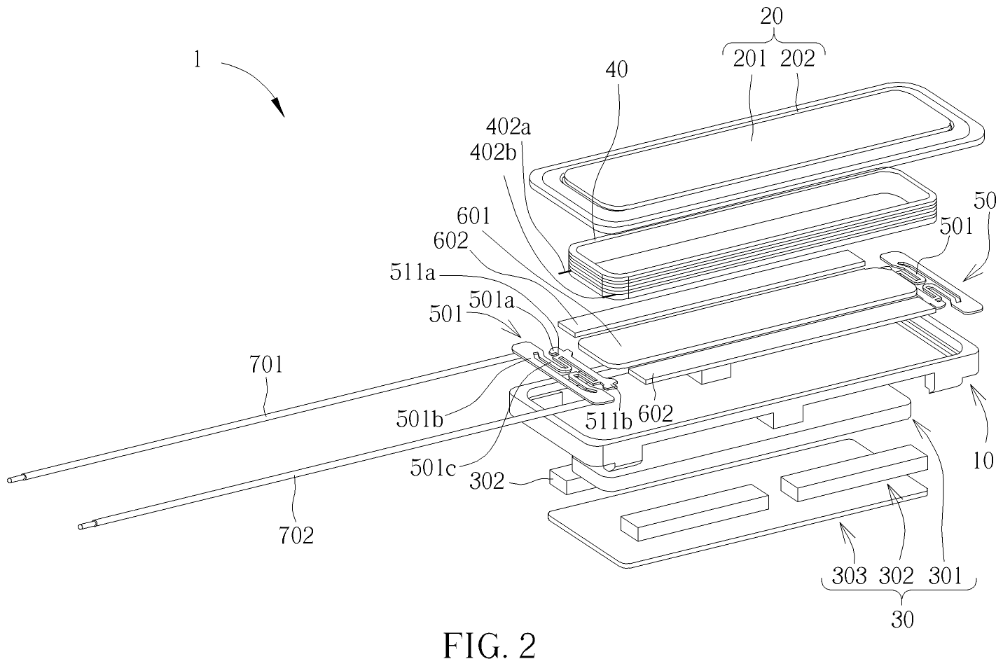

Please refer to FIG. 1 and FIG. 2. FIG. 1 is a schematic diagram of the appearance of a micro-speaker according to an embodiment of the present invention. FIG. 2 is an exploded view of the micro-speaker in FIG. 1. As shown in FIGS. 1 and 2, according to an embodiment of the present invention, the micro-speaker 1 includes a frame body 10 and a drum paper 20 provided on the frame body 10. According to an embodiment of the present invention, the drum paper 20 may include a diaphragm 201 and a surround 202. The surround 202 encircles the diaphragm 201 and has an arc-shaped or wavy-shaped cross-section. According to an embodiment of the present invention, the diaphragm 201 and the surround 202 may be composed of different materials, but are not limited thereto.

According to an embodiment of the present invention, preferably, the drum paper 20 is flexibly connected to the upper end of the frame body 10. According to an embodiment of the present invention, the diaphragm 201 may be arranged in a slender shape, that is, the size in the length direction is larger than the size in the width direction. According to an embodiment of the present invention, the frame body 10 has an opening that matches the shape of the drum paper 20 and the diaphragm 201, and the diaphragm 201 is connected to the frame body 10 through the ring-shaped surround 202 to seal the opening.

According to an embodiment of the present invention, a magnetic structure 30 is provided in the frame body 10. The magnetic structure 30 includes a main magnetic portion 301, a side magnetic portion 302 around the outer periphery of the main magnetic portion 301, and a yoke 303 located below the main magnetic portion 301 and the side magnetic portion 302. According to an embodiment of the present invention, a gap is provided between the main magnetic portion 301 and the side magnetic portion 302. According to an embodiment of the present invention, washers 601 and 602 for magnetic conduction are provided on the main magnetic portion 301 and the side magnetic portion 302, respectively.

According to an embodiment of the present invention, a voice coil 40 is provided in the frame body 10. According to an embodiment of the present invention, the voice coil 40 is formed by windings of insulated wire and does not require a bobbin. The voice coil 40 is disposed around the outer periphery of the main magnetic portion 301 and installed in the gap in a vertical direction. According to an embodiment of the present invention, the voice coil 40 is arranged in a slender shape, that is, the size in the length direction is larger than the size in the width direction, and the upper end of the voice coil 40 is fixedly connected to the diaphragm 201. Preferably, in an embodiment of the present invention, the center of the voice coil 40 is located on the central axis of the diaphragm 201 in the longitudinal direction. A magnetic field is provided through the magnetic structure 30 to vibrate the voice coil 40 and drive the diaphragm 201 to vibrate and produce sound.

According to an embodiment of the present invention, a voice coil balancing system 50 is additionally provided in the frame body 10, which is mainly composed of two symmetrically arranged dampers 501. According to an embodiment of the present invention, the two dampers 501 are arranged under the two ends of the long axis of the voice coil 40 and fixed with glue. According to an embodiment of the present invention, the damper 501 is composed of a flexible printed circuit (FPC).

According to an embodiment of the present invention, the damper 501 mainly includes a first end 501a, a second end 501b, and a cantilever 501c connecting the first end 501a and the second end 501b. There are hollow parts between the first end 501a, the second end 501b and the cantilever 501c. The dampers 501 are fixed under the two ends of the long axis of the voice coil 401 with glue through the first ends 501a, and fixed under the two ends of the long axis of the frame body 10 with glue through the second ends 501b. The voice coil leads 402a and 402b are respectively fixedly connected to the welding parts 511a and 511b of the first end 501a on the front side of the damper 501 through spot welding, and are electrically connected to the circuit on the bottom surface of the damper 501, which is further electrically connected to the connection terminals on the bottom surface of the second end 501b of the damper 501.

According to an embodiment of the present invention, the connection terminals on the bottom surface of the second end 501b are welded to the external signal wires 701 and 702, respectively, and connected to an external circuit, so as to input the external audio signal through the damper 501, so that the diaphragm 201 vibrates and emits sound.

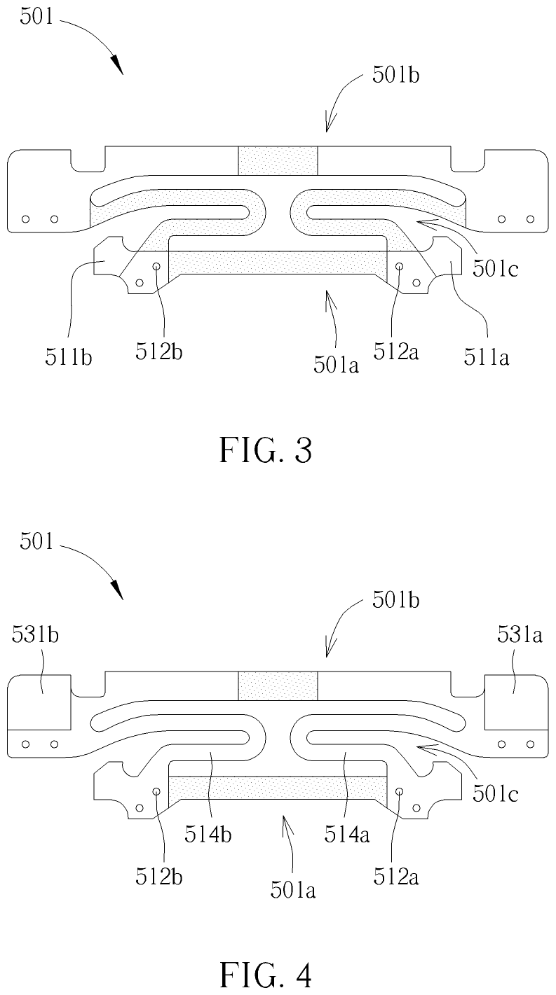

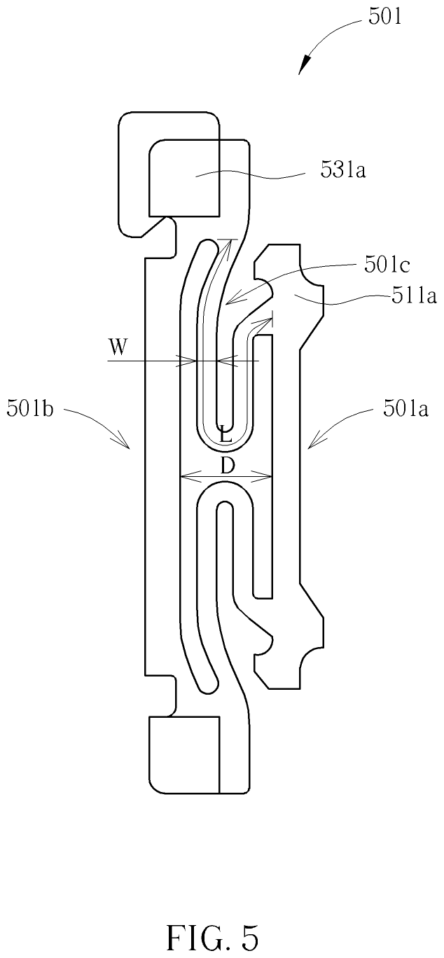

Please refer to FIG. 3 to FIG. 5. FIG. 3 illustrates a schematic diagram of the front-side layout of the damper 501, FIG. 4 illustrates a schematic diagram of the bottom-side layout of the damper 501, and FIG. 5 shows the length L, width W and distribution distance D of the cantilever 501c of the damper 501. As shown in FIG. 3 and FIG. 4, the damper 501 has a left-right symmetrical structure. In order to enable the FPC damper 501 to provide sufficient elasticity and damping, the cantilever 501c has no copper layer on the front surface of the damper 501. According to an embodiment of the present invention, the substrate of the FPC damper 501 may be composed of a polymer material, such as polyimide resin, but is not limited thereto.

As shown in FIG. 3 and FIG. 4, the voice coil leads 402a and 402b can be fixed to the welding parts 511a and 511b of the first end 501a on the front surface of the damper 501 through spot welding, and electrically connected to the circuit disposed on the bottom surface of the damper 501 through the via holes 512a and 512b, respectively. As previously mentioned, the cantilever 501c has a copper layer only on the bottom surface of the damper 501 (as shown in FIG. 4), which is electrically connected to the connection terminals 531a and 531a on the bottom surface of the second end 501b. The aforementioned external signal wires 701 and 702 are respectively soldered to the connection terminals 531a and 531b on the bottom surface of the second end 501b. According to an embodiment of the present invention, since the cantilever 501c has only a single-sided copper layer, sufficient elasticity and damping can be provided in this way to pass the life test under high power operation.

As shown in FIG. 5, the length L of the cantilever 501c refers to the length of the cantilever 501c extending between the first end 501a and the second end 501b, and the cantilever distribution distance D refers to the area width between the first end 501a and the second end 501b where the serpentine or curved cantilever 501c is distributed. According to an embodiment of the present invention, taking a cantilever width of 0.45 mm as an example, a ratio of the cantilever length L to the cantilever distribution distance D ranging between 2-15 is required.

According the present disclosure, two independent FPC dampers 501 are provided as buffer media, and the voice coil amplitude is borne by the FPC dampers 501 instead of the voice coil leads in the conventional design. The FPC dampers 501 can provide enough elasticity and damping, so that the micro-speakers can also bear the amplitude brought by high power, thereby increasing the rated power (even in the case of reduced size, it can still provide large volume), and pass life test under high-power operation. In addition, the shape, style, and thickness of the two independent FPC dampers 501 can be adjusted according to the vibration mode of the diaphragm 201, thereby making the vibration behavior of the micro-speaker more optimized to provide better sound quality. During the manufacturing process of the two independent FPC dampers 501, they can be connected to the frame body 10 in advance as a semi-finished product, which will simplify the complexity of the assembly and manufacturing process of the micro-speakers.

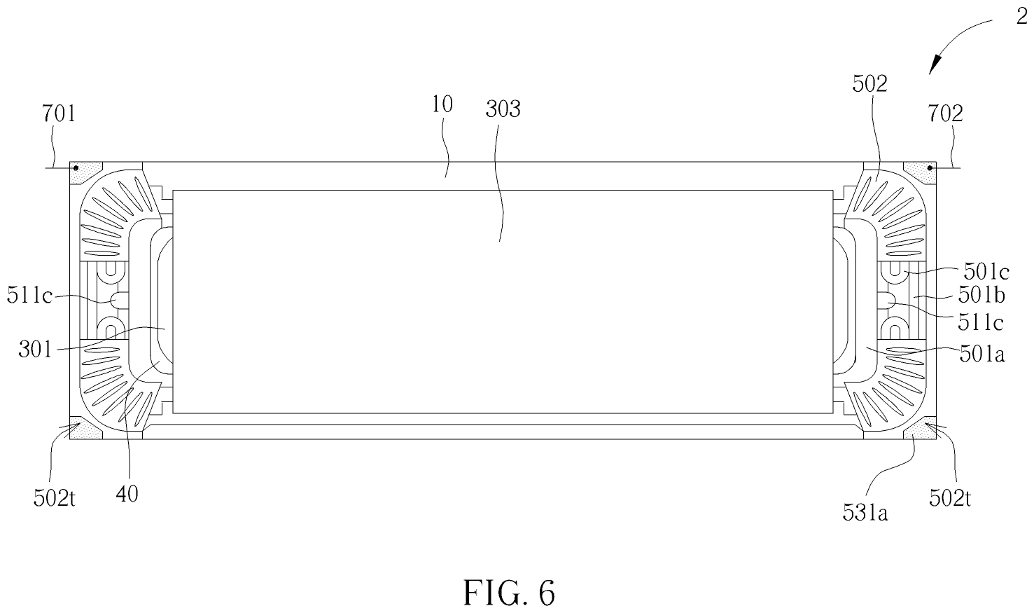

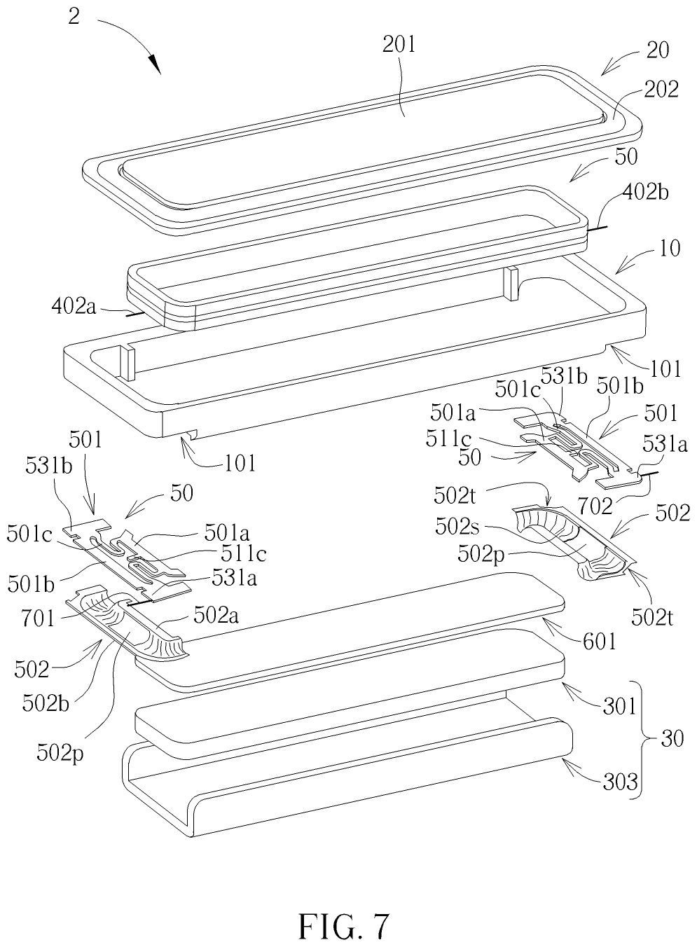

FIG. 6 is a schematic bottom of bottom view of a micro-speaker according to another embodiment of the present invention. FIG. 7 is an exploded view of the micro-speaker in FIG. 6. As shown in FIG. 6 and FIG. 7, likewise, the micro-speaker 2 includes a frame body 10 and a drum paper 20 arranged on the frame body 10. According to an embodiment of the present invention, the drum paper 20 may include a diaphragm 201 and a surround 202 encircling the diaphragm 201. The cross section of the surround 202 may be an arc-shaped or wave-shaped profile. According to an embodiment of the present invention, the diaphragm 201 and the surround 202 may be composed of different materials, but are not limited thereto.

According to an embodiment of the present invention, preferably, the drum paper 20 is flexibly connected to the upper end of the frame body 10. According to an embodiment of the present invention, the diaphragm 201 is arranged in a slender shape, that is, the size in the length direction is larger than the size in the width direction. According to an embodiment of the present invention, the frame body 10 has an opening that matches the shape of the drum paper 20 and the diaphragm 201, and the diaphragm 201 is connected to the frame body 10 through the ring-shaped surround 202 to seal the opening.

According to an embodiment of the present invention, a magnetic structure 30 is provided in the frame body 10, including a main magnetic portion 301 and a yoke 303 located below the main magnetic portion 301. According to an embodiment of the present invention, the magnetic structure 30 is a single-magnet magnetic system, that is, no side magnetic parts are provided on both sides of the main magnetic part 301. According to an embodiment of the present invention, the cross section of the yoke 303 has a U-shaped profile. According to an embodiment of the present invention, the length of the yoke 303 is slightly shorter than that of the main magnetic portion 301 and the width of the yoke 303 is greater than that of the main magnetic portion 301. According to an embodiment of the present invention, a gap is provided between the main magnetic part 301 and the yoke 303. According to an embodiment of the present invention, a washer 601 for magnetic conduction is provided on the main magnetic portion 301.

According to an embodiment of the present invention, a voice coil 40 is provided in the frame body 10. According to an embodiment of the present invention, the voice coil 40 is formed by windings of insulated wire and does not require a bobbin. The voice coil 40 is disposed around the outer periphery of the main magnetic portion 301 and installed in the gap in a vertical direction. According to an embodiment of the present invention, the voice coil 40 is arranged in a slender shape, that is, the size of the voice coil 40 in the length direction is larger than the size in the width direction, and the upper end of the voice coil 40 is fixedly connected to the diaphragm 201. Preferably, in an embodiment of the present invention, the center of the voice coil 40 is located on the central axis of the diaphragm 201 in the longitudinal direction. A magnetic field is provided through the magnetic structure 30 to vibrate the voice coil 40 and drive the diaphragm 201 to vibrate and produce sound.

According to an embodiment of the present invention, a voice coil balancing system 50 is provided in the frame body 10, which is mainly composed of two symmetrically arranged dampers 501 and two symmetrically arranged elastic members 502. According to an embodiment of the present invention, the two dampers 501 and the two elastic members 502 are arranged in pairs on the mounting portion 101 below the two opposite ends of the long axis of the frame body 10. For example, one damper 501 may be glued and fixed to the recessed mounting portion 101 of the frame body 10 together with one elastic member 502.

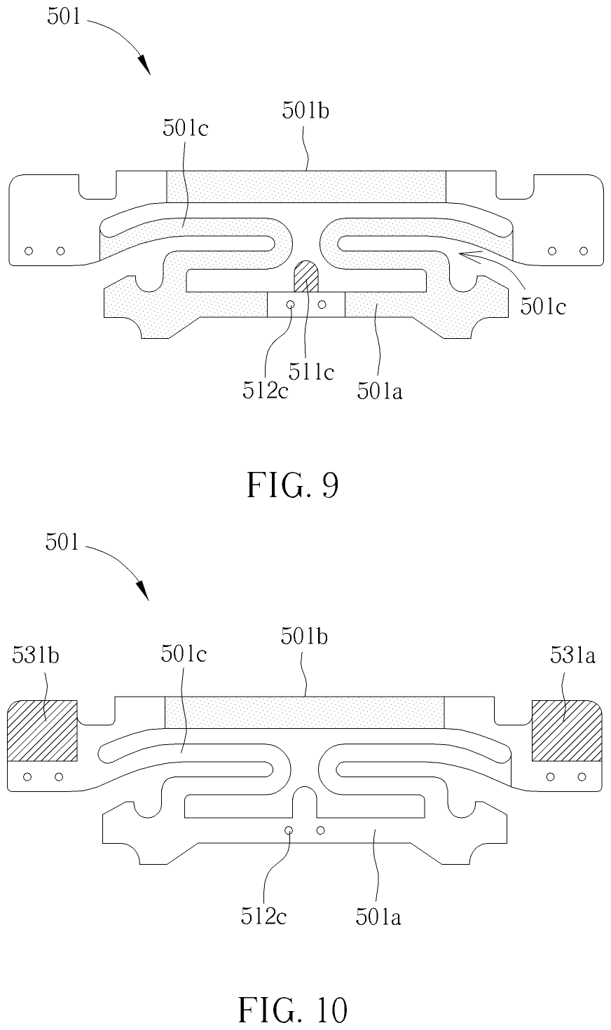

According to an embodiment of the present invention, the damper 501 is composed of a flexible circuit board. As shown in FIG. 9 and FIG. 10, the voice coil lead can be fixed to the welding part 511c of the first end 501a on the front surface of the damper 501 by spot welding. The welding part 511c can be plated with tin or other solderable materials. It is then connected to the circuit on the bottom surface of the damper 501 through the conductive via 512c. That is, only on the bottom surface of the damper 501, there is a copper layer on the cantilever 501c (the copper layer in FIG. 9 and FIG. 10 is represented by a blank area), connected to the connection terminals 531a and 531b on the bottom surface of the second end 501b. On the front surface of the damper 501, the surface of the substrate of the cantilever 501c can be exposed or the surface of the substrate may be covered with an insulating layer (as shown in the dotted area in FIG. 9). The aforementioned external signal wires 701 and 702 can be respectively welded to the connection terminals 531a and 531b on the bottom surfaces of the second ends 501b.

According to an embodiment of the present invention, the elastic member 502 may be a composite film with a sandwich structure, for example, a composite sandwich structure of polyether ether ketone (PEEK)/adhesive layer/PEEK, or a composite sandwich structure of thermoplastic polyester elastomer (TPEE)/adhesive layer/TPEE, but is not limited thereto. The adhesive layer can be acrylic glue, but is not limited thereto. According to another embodiment of the present invention, the elastic member 502 may be a single material, such as silicone resin, but is not limited thereto. The elastic member 502 can increase the stability of the voice coil 40 when it moves.

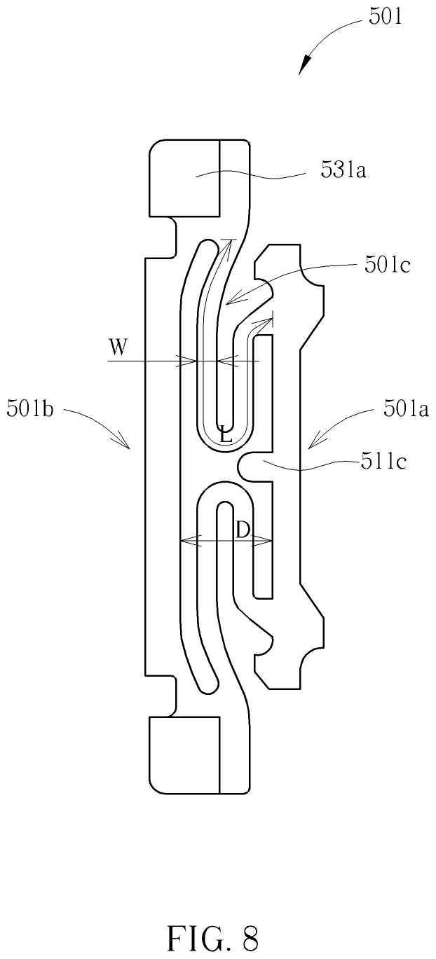

According to an embodiment of the present invention, as shown in FIG. 8, the damper 501 includes a first end 501a, a second end 501b, and a cantilever 501c connecting the first end 501a and the second end 501b. There are hollow parts between the first end 501a, the second end 501b and the cantilever 501c. The dampers 501 are fixed to the mounting portions 101 located under the two opposite ends of the long axis of the frame body 10 with glue through the second end 501b. The voice coil leads 402a and 402b located under the two opposite ends of the long axis of the voice coil 401 are respectively fixedly connected to the welding parts 511c in the middle of the first ends 501a of the dampers 501 through spot welding, and are electrically connected to the circuits on the bottom surface of the dampers 501 through the via hole, and is further electrically connected to the connection terminals 531a and 531b of the second ends 501b through the circuits on the bottom surface of the dampers 501. According to an embodiment of the present invention, the welding portion 511c protrudes toward the second end portion 501b and is positioned approximately in the middle of the first end portion 501a between the two cantilevers 501c. According to an embodiment of the present invention, by arranging the welding portion 511c at the middle position of the first end 501a, the yield of spot welding can be improved.

According to an embodiment of the present invention, the circuit on the damper 501 may be a single-sided circuit, that is, only a single-sided copper layer is provided on the bottom surface of the damper 501, which can provide sufficient elasticity and damping. However, in some embodiments, the circuit on the damper 501 may be a double-sided circuit.

According to an embodiment of the present invention, as shown in FIG. 8, the length L of the cantilever 501c refers to the length of the cantilever 501c from the first end 501a to the second end 501b, and the cantilever distribution distance D refers to the area width between the first end 501a and the second end 501b where the serpentine or curved cantilever 501c is distributed. According to an embodiment of the present invention, taking a cantilever width of 0.45 mm as an example, a ratio of the cantilever length L to the cantilever distribution distance D ranging between 2-15 is required.

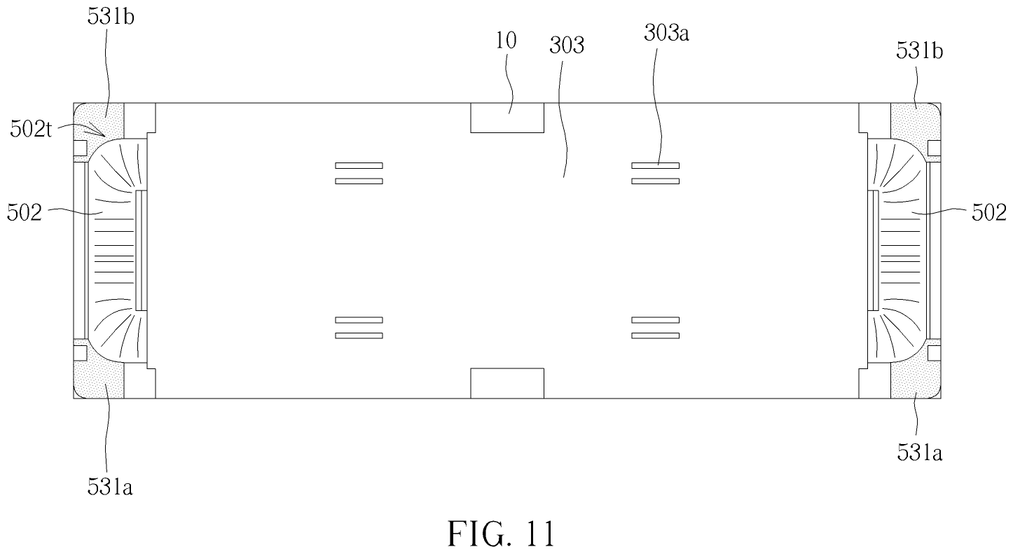

According to an embodiment of the present invention, the elastic member 502 includes an inner edge portion 502a and an outer edge portion 502b, the shapes of which correspond to the first end portion 501a and the second end portion 501b of the damper 501, respectively. The elastic member 502 is adhered to the first end 501a and the second end 501b of the damper 501 through the inner edge portion 502a and the outer edge portion 502b, respectively. Between the inner edge portion 502a and the outer edge portion 502b is a connecting portion 502s, which may have a wavy or arc-shaped cross-sectional profile, and may have wrinkles. According to an embodiment of the present invention, the connecting portion 502s may be discontinuous. For example, the connecting portion 502s is only arranged at a corner, and there may be an opening 502p in the middle to expose part of the damper 501. According to another embodiment of the present invention, as shown in FIG. 11, the connecting portion 502s may be continuous, covering the entire damper 501. In FIG. 11, the shape and structure of the damper 501 can be the same as those in FIG. 2 to FIG.

[symbol]

According to an embodiment of the present invention, the elastic member 502 includes a truncation portion 502t, which exposes the connecting terminals 531a and 531b of the second end 501b, and the external signal wires 701 and 702 are welded through the connecting terminals 531a and 531b, respectively. It is connected to input the external audio signal through the damper 501, so that the diaphragm 201 vibrates and produces sound.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A micro-speaker, comprising: a frame body, a diaphragm arranged on the frame body, a magnetic structure and a voice coil arranged in the frame body, wherein an upper end of the voice coil is fixed to the diaphragm, the magnetic structure is arranged under the voice coil, and the micro-speaker is characterized in that a voice coil balancing system is provided in the frame body, which is composed of two symmetrically arranged dampers and two symmetrically arranged elastic members, which are paired and respectively arranged at mounting portions under two opposite ends of a long axis of the frame body and fixed with glue, wherein each of the two dampers is made of a flexible circuit board, including a first end, a second end and a cantilever connecting the first end and the second end, and wherein a ratio of a length L of the cantilever to a distribution distance D of the cantilever is between 2-15.

2. The micro-speaker according to claim 1, wherein each of the two dampers has a left-right symmetrical structure.

3. The micro-speaker according to claim 1, wherein the cantilever has no copper layer on a front surface of each of the two dampers.

4. The micro-speaker according to claim 3, wherein each of the two dampers comprises a substrate that is made of a polymer material.

5. The micro-speaker according to claim 1, wherein a voice coil lead is fixed to a welding part located at a center portion of the first end on a front surface of each of the two dampers by using spot welding, which is connected to a circuit on a bottom surface of each of the two dampers through a via hole, which is electrically connected to a connection terminal on the bottom surface of the second end.

6. The micro-speaker according to claim 5, wherein an external signal wire is welded to the connection terminal on the bottom surface of the second end.

7. The micro-speaker according to claim 1, wherein a width of the cantilever is 0.45 mm.

8. The micro-speaker according to claim 1, wherein the diaphragm is arranged in a slender shape, and wherein a size of the diaphragm in a length direction is larger than a size in a width direction.

9. The micro-speaker according to claim 8, wherein the frame body has an opening that matches a shape of the diaphragm, and the diaphragm is connected to the frame body through a ring-shaped surround to seal the opening.

10. The micro-speaker according to claim 1, wherein the magnetic structure includes a main magnetic portion and a yoke under the main magnetic portion, and wherein a gap is located between the main magnetic portion and the yoke, and the voice coil is disposed around the outer periphery of the main magnetic portion and installed in the gap.

11. The micro-speaker according to claim 10, wherein a washer for magnetic conduction is provided on the main magnetic portion.

12. The micro-speaker according to claim 1, wherein the dampers are fixed under the two opposite ends of the long axis of the frame body with the glue through the second ends.

13. The micro-speaker according to claim 1, wherein each of the two elastic members is a composite film with a sandwich structure.

14. The micro-speaker according to claim 13, wherein the composite film comprises a composite sandwich structure of polyetheretherketone/adhesive layer/polyetheretherketone or a composite sandwich structure of thermoplastic polyester elastomer/adhesive layer/thermoplastic polyester elastomer, wherein the adhesive layer is acrylic glue.

15. The micro-speaker according to claim 1, wherein each of the two elastic members is composed of a single material.

16. The micro-speaker according to claim 15, wherein the single material is silicone resin.

17. The micro-speaker according to claim 1, wherein each of the two elastic members includes an inner edge portion and an outer edge portion, the shapes of which respectively correspond to the first end and the second end of the damper, wherein the inner edge portion and the outer edge portion of each of the two elastic members are adhered to the first end and the second end of the damper, respectively.

18. The micro-speaker according to claim 17, wherein each of the two elastic members is provided with a connecting portion between the inner edge portion and the outer edge portion, which has a wavy or arc-shaped cross-sectional profile and has wrinkles.

19. The micro-speaker according to claim 18, wherein the connecting portion is discontinuous and is arranged at a corner with an opening in the middle to expose part of the damper.

20. The micro-speaker according to claim 18, wherein the connecting portion is continuous and completely covers the damper.
